(19) United States
(12) Patent Application Publication
(10) Pub. No.: US 2007/0035460 A1
(43) Pub. Date: Feb. 15, 2007

(54) High-frequency motor-vehicle antenna

(75) Inventor: Gunther Blickle, Walddorfhaslach (DE)

Correspondence Address: THE FIRM OF KARL F ROSS, 5676 RIVERDALE AVENUE, PO BOX 900, RIVERDALE (BRONX), NY, 10471-0900, US

(73) Assignee: HIRSCHMANN CAR COMMUNICATION GMBH

(21) Appl. No.: 11/502,588

(22) Filed: Aug. 10, 2006

(30) Foreign Application Priority Data
Aug. 12, 2005 (DE) 102005038197.9

(51) Int. Cl. H01Q 1/32

(52) U.S. Cl. 343/713

(57) ABSTRACT

A high-frequency motor-vehicle antenna has a lower housing part adapted to be secured to the motor vehicle, at least partially dielectric, and formed with an inner and an outer annular side wall and an upper housing part formed with an inner and an outer annular side wall fittable with the respective walls of the lower part. The upper and lower housing parts are fitted together with the side walls fitting hermetically. The inner and outer side walls form aligned inner and outer throughgoing ports when the parts are fitted together. A cable extends through the ports, and a seal is integrally mounted on the cable and sealingly fits in both of the ports.

### FIELD OF THE INVENTION

The present invention relates to a motor-vehicle antenna. More particularly this invention concerns such an antenna mounted permanently on the vehicle and intended to send and/or receive high-frequency radio signals.

### BACKGROUND OF THE INVENTION

Vehicle antennas, particularly roof antennas that are mounted to the vehicle roof, are well known. These antennas have a base plate made of metallic material and used to fasten the antenna to the vehicle roof by means of a threaded pin and a fastening nut. The threaded pin has an central passage through which pass cables attached to the antenna elements are fed. A housing or hood of the roof antenna protects the antenna elements and seals the antenna elements and the opening in the vehicle roof to the outside, if necessary on its own or together with the base plate. Here the sealing of a cable that is guided through the housing component of the antenna is not a problem. An example of sealing a vehicle antenna against the vehicle roof is disclosed in U.S. Pat. No. 6,999,033.

It is generally common for housings to guide a cable through a side wall of the housing, for which purpose the side wall is provided with an opening. The cable is guided through this opening and glued in place there, in which case the sealing effect is not reliable and the bonding procedure is complex and not environmentally safe. Alternately a seal, for example a rubber bushing, is fitted over the cable and fixed in the opening of the housing side wall. Such a sealing method of the cable in relation to the housing is satisfactory for normal uses of electronic devices, however not for vehicle antennas that are attached to an external component of the vehicle, for example the vehicle roof, and exposed to very arduous environmental conditions such as temperature variations, wind, dirt particles, and humidity, particularly when driving through a car wash or traveling at high speed. Therefore, such sealing of the cable by means of a rubber bushing is quickly subject to humidity and impurity infiltrations into the antenna housing, resulting in malfunctions or failures of the antennas. Furthermore, the tension strain cannot be relieved sufficiently by a rubber bushing.

### OBJECTS OF THE INVENTION

It is therefore an object of the present invention to provide an improved high-frequency motor-vehicle antenna.

Another object is the provision of such an improved high-frequency motor-vehicle antenna that overcomes the above-given disadvantages, in particular that provides for a very good sealing of a cable passing through a housing side wall, that is not up through the rough and the bottom wall of the housing.

A further object is to provide such an antenna that offers very good strain relief for the cable, so that even a very strong tug on the cable will not pull it free or impair the seal in the side wall where it is traversed by the cable.

Yet another object is to provide such a housing normally made of dielectric material and intended to be an after-market item, that is not something installed on the vehicle at the assembly plant but, instead, something mounted later by an after-market installer or the owner himself or herself, even so that it can be detached.

### SUMMARY OF THE INVENTION

A high-frequency motor-vehicle antenna has according to the invention a lower housing part adapted to be secured to the motor vehicle, at least partially dielectric, and formed with an inner and an outer annular side wall, an upper housing part formed with an inner and an outer annular side wall fittable with the respective walls of the lower part, means securing the upper and lower housing parts together with the side walls fitting hermetically together. The inner and outer side walls forming aligned inner and outer throughgoing ports when the parts are fitted together, a cable extending through the ports, and a seal integrally mounted on the cable and sealingly fitting in both of the ports.

According to invention, on the one hand the housing of the antenna comprises a lower part and an upper part that each have an outer side wall, particularly a locking side wall, as well as an inner side wall, particularly extending parallel to the outer side wall, and that the seal extends over an outer and an inner side wall. Extending both side walls substantially parallel to each other creates an intermediate space that guarantees effective sealing of the internal antenna area holding the antenna elements and any delicate electronic components.

To this end, both parts can be connected detachably or non-detachably, a detachable connection particularly obtained by means of a positive or form fit, optionally with a further seal engaged between the side walls. Furthermore, it is advantageous that the seal that is provided above the cable that is to be fed, extends through outer and inner side walls that have corresponding ports for accommodating the seal. This guarantees that, if humidity or impurities penetrate into the intermediate space from the outer side wall, they do not directly and/or at all reach the antenna elements because the inner side wall prevents them from doing so. This means that the seal provides a sealing effect to the outside and inside relative to the interior of the antenna.

Also according to invention the lower and upper parts each have an outer side wall as well as means for relieving strain of the cable via the seal and that the seal extends through an outer side wall and the strain-relief means. This provides a simple way for achieving a sealing effect as well as strain relief.

For the purpose of simple assembly of the antenna, a further development of the invention provides that the outer and inner side walls of the lower part each have an opening through which the seal and cable are fed. This way, the lower part can be produced as one piece, particularly in a plastic injection molding process, together with the side walls and the opening for receiving the seal. This also applies to the upper part. This way, the cable and the seal can be fed through both side walls of the lower part and afterward an electrical connection can be established with a printed circuit board that carries the antenna elements. Alternately, an assembly is conceivable in which the cable and the seal are already electrically connected to the printed circuit board and are mounted from the inside toward the outside of the housing.

In a further development of the invention, the seal is integrally connected to the outer insulation jacket of the cable. This integral connection increases the sealing effect by closing any gap that avoids the infiltration of humidity or impurities between the outer casing of the cable inward past the seal. Possible methods for producing the integral connection are adhesive methods or alternatively it is also conceivable to mold the seal to the outer casing of the cable, thus resulting in a form fit connection of the cable (more precisely its outer casing) with the seal, so that a preassembled, optionally with plug connectors, wiring harness that is provided with the seal is available for further assembly.

### BRIEF DESCRIPTION OF THE DRAWING

The above and other objects, features, and advantages will become more readily apparent from the following description, reference being made to the accompanying drawing in which:

FIG. 1 is a perspective top view of the bottom part with the cable and electrical components according to the invention;

FIG. 2 is a perspective bottom view of the top part;

FIG. 3 is a large-scale view of the detail indicated at III in FIG. 1;

FIG. 4 is a section through the assembled antenna in accordance with the invention;

FIG. 5 is a large-scale view of the detail indicated at V in FIG. 4; and

FIG. 6 is a perspective section view taken along section plane VI-VI of FIG. 5.

### SPECIFIC DESCRIPTION

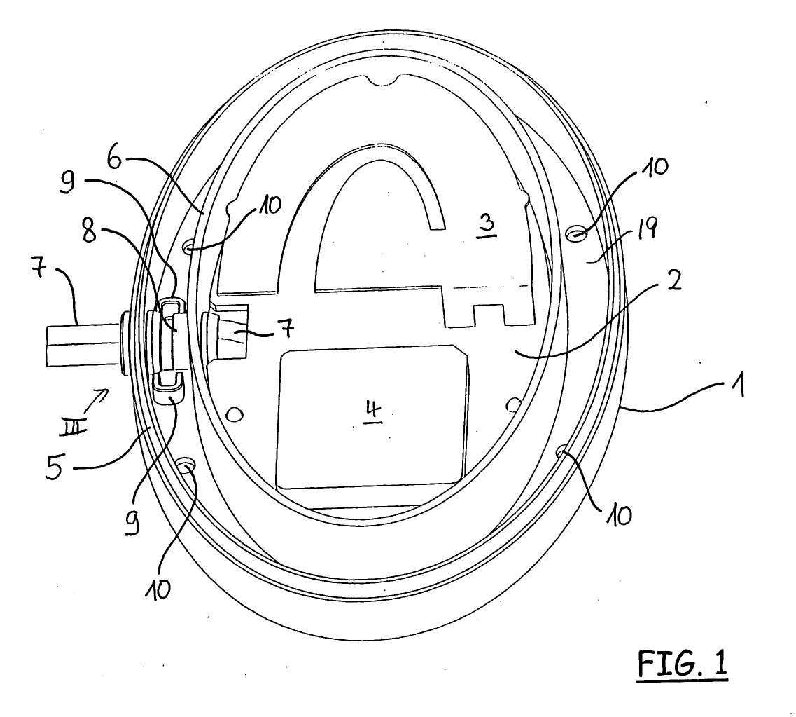

As seen in FIG. 1 a lower part 1 of a housing of an antenna has a printed circuit board 2 or support. In the embodiment, a first antenna element 3 is present that is configured for two frequency bands for receiving high-frequency signals as a result of its shape. A further antenna element is a GPS-receiver 4 that is provided as a prefabricated module fixed to the printed circuit board 2. The lower side of the printed circuit board 2, which is not shown, has electrically conductive traces that connect the antenna elements 3 and 4 to a cable 7.

An annular outer side wall 5 forms the outer contour of the lower part 1. Parallel (or alternatively deviating from it), an annular inner side wall 6 is provided at a defined distance inward of the outer side wall 5, so that together these two side walls 5 and 6 create an annular intermediate space 19. At least one single- or multi-core shielded or unshielded cable 7 (also more than two cables, such as the two cables 7 shown in the illustrated embodiment) are guided through ports 20 and 21 in the side walls 5, 6. The cable 7 connects the antenna elements 3 and 4 with an electronic device, e.g. a radio receiver, cell-phone unit, or car computer, that is not shown and not described in detail.

A seal 8 that is fixed to the jacket of the cable 7 and forms an outward seal of the antenna housing, extends from outside the outer side wall 5 toward the printed circuit board 2. Seats 9, the function of which is explained below, are provided around the seal 8 in the intermediate space 19 between the two side walls 5 and 6. For the connection, particularly a detachable connection, of the lower part 1 illustrated in FIG. 1 with an upper part that is not shown here, openings 10 are provided through which, for example, screws can be fitted and seated in the upper part.

The lower part 1 shown in FIG. 1 with the described elements has the advantage that it is easy to make, for example from plastic by an injection-molding process, while the seal 8 on the outer casing of cable 7 is molded on, and has the necessary shape for receiving the printed circuit board 2. The printed circuit board 2 can, for example, be glued, bolted, caulked or similarly attached to the lower part 1. FIG. 1 shows how the lower part 1 has an outer side wall 5 as well as an inner side wall 6 and that the seal 8 extends through both side walls 5 and 6.

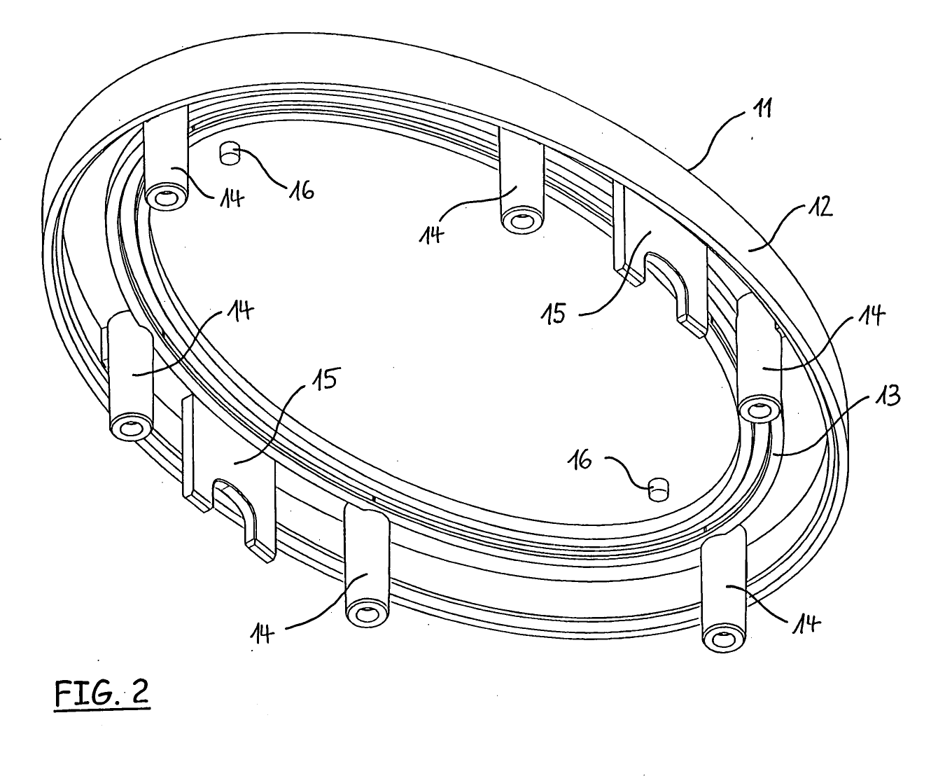

FIG. 2 shows an upper part 11 of the antenna that has an oval shape that corresponds to that of the lower part 1. The upper part 11 also has an outer side wall 12 and an inner side wall 13. By means of spacer posts 14 that correspond to the openings 10 of the lower part 1, the lower part 1 and upper part 11 can be detachably connected by means of screws. Furthermore, the upper part 11 has downward pointing lugs 15 that are preferably, but not necessarily, symmetrically disposed for easier assembly, and which can interact with the seal 7 and fit in the seats 9 when the lower part 1 and upper part 11 are fitted together. If only one seal 8 is present, one downward pointing lug 15 suffices on the upper part 11. Likewise, the upper part 11 has inward facing spacers 16 that are shaped and extend such that in the fitted state of the upper part 11 they press on the antenna element 3 and/or the GPS-receiver 4 so as to fix them in place and eliminate any chance of vibration.

Overall, the lower part 1 according to FIG. 1 and the upper part according to FIG. 2 are configured such that they can be assembled with their flat surfaces extending generally parallel to each other so as to provide a very flat design. Alternatively to the screw connection of the two parts 1 and 11 via the openings 10 and spacer posts 14, it is conceivable that the two parts 1 and 11 engage each other when pressed together. Alternatively or additionally, welding (for example ultrasonic welding), gluing or the like are possible. In addition, the two parts 1 and 11 are configured symmetrically with their elements for easier assembly. The housing may also have at least one further outlet for a cable.

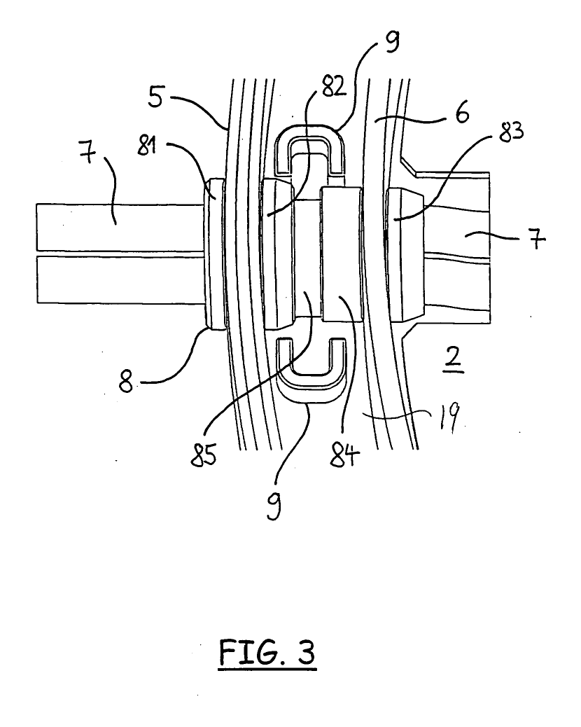

FIG. 3 shows a detailed view of the installed seal 8 that has thickened regions 81 and 82 that fit tightly against outer and inner faces of the side wall 5 at the port 21 and thickened regions 83 and 84 that similarly fit tightly against inner and outer faces of the side wall 16 at the port 20. With these thickened regions 81 to 84, the seal 8 rests flush against the wall faces around the ports 20 and 21 in the side walls 5 and 6 and therefore seals tightly, with the distance of the mutually facing surfaces of the thickened regions 81 and 82 and 83 and 84 being preferably selected somewhat smaller than the thickness of the respective side wall 5 and 6. The seal 8 is extends between both seats 9 on the lower part 11 and has a groove or indentation 85 whose function is explained below.

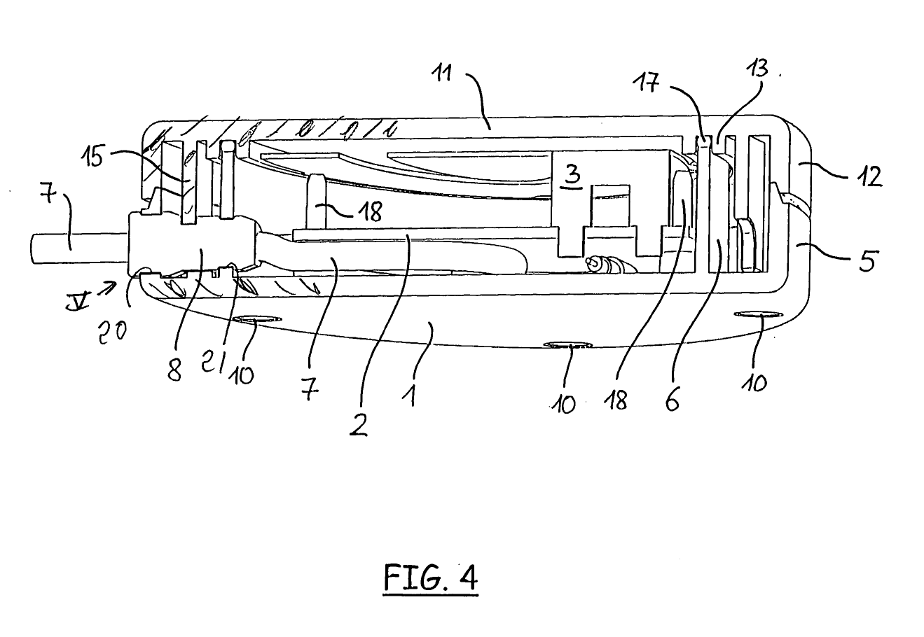

FIG. 4 shows a sectional view through the assembled antenna, with the upper part 11 attached to the lower part 1. In order to seal the interior of the antenna, a peripheral seal 17 is fitted between the inner side wall 6 of the lower part 1 and the corresponding groove-shaped inner side wall 13 of the upper part 11. This seal 17 ensures that the interior of the antenna, in which the printed circuit board 2 with the antennas 3 and 4 is located, is sealed against the intermediate space 19 and outside the housing. The seal 17 can be a separate component or be fastened, particularly glued or molded, to the lower part 1 and/or the upper part 11. The lower part 1 or circuit board 2 has at least one spacer 18 that presses from below against the flush antenna element 3, so as to eliminate the possibility of vibration of the antenna elements, like the spacer 16. In addition to the spacers 16 and 18, vibration of the antenna elements, can also be prevented by spacers that fix the printed circuit board 2 in its defined position on the lower part 1 or even on the upper part 11. The peripheral outer side walls 5 and 12 are shaped such that they act as guides when the two parts 1 and 11 are assembled, for example by means of a chamfer, and can snap-fit into each other, with if necessary interposition of a seal. The spacers 16 and 18 can also be provided separately from the parts 1 and 11. In this case they are, for example, made of foam material or another generally flexible ductile element and are glued to the parts 1 and 11 or to the antenna elements 3 and is 4 or printed circuit board 2. Alternatively, they can also be interposed without any kind of attachment.

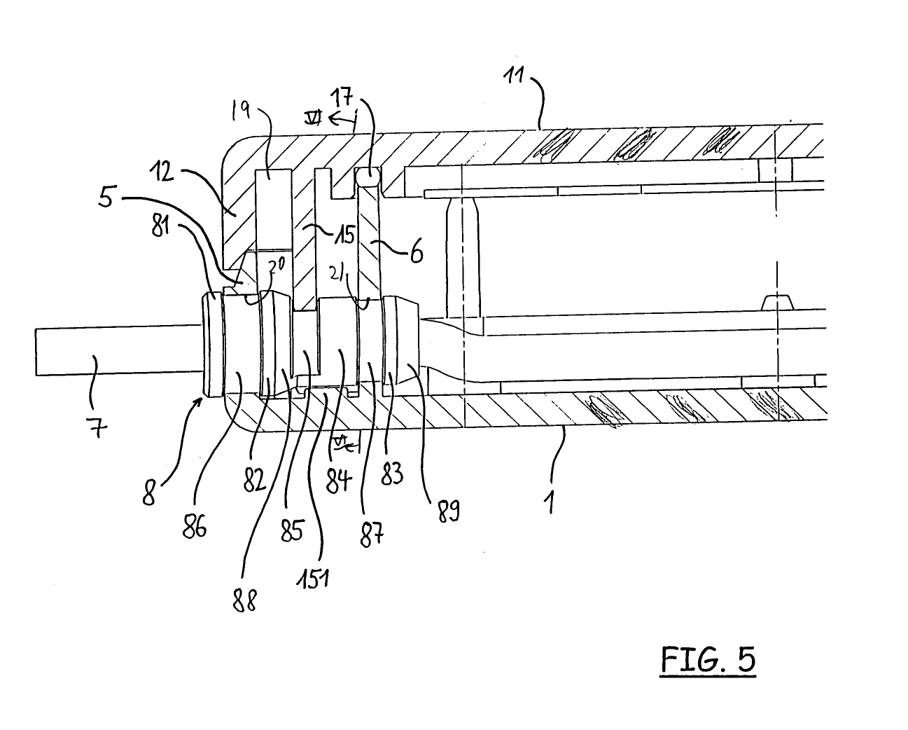

FIG. 5 shows a detailed view of the flexible ductile seal 8 that is installed in its defined position in the antenna housing. Both parts 1 and 11 fit with the seal 8 to create the excellent sealing of the interior of the antenna with respect to the outside. First, the seal 8 with its thickened regions 81 and 82 is fitted to the outer side wall 5 and creates a first seal there when pressed from the outside in the ports of the housing.

The second seal is created by fitting the seal 8 with its thickened regions 83 and 84 to the inner side wall 6. The indentation 85 fits complementarily with a cutout of the lug 15 projecting from the upper part 11, and this lug 15 engages in the seats 9 and thus provides strain relief at the seal 8 and thus for the entire cable 7. The strain relief is created by an engagement of the lug 15 during assembly in the indentation 85 of the seal 8 and by fitting in the seats 9, thus absorbing the tensile or pressure forces on the cable 7. In addition, the seal 8 is firmly connected to the outer casing of the cable 7, particularly it is molded, glued or attached otherwise to the outer casing in an integral connection. To this end, the width of the groove or indentation 85 is advantageously selected such that it is smaller than or equal to the thickness of the lug 15. In the area of the ports of the side walls 5 and 6, the seal 8 also has grooves or indentations 86 and 87, the diameter in this area being somewhat greater than the diameter of the respective opening in the side wall 5 and 6 in order to obtain an optimal sealing effect as a result of the elastic compressibility of the seal 8. This also applies to the width of the indentations 86 and 87 that is slightly smaller than the thickness of the side walls 5 and 6. Furthermore, it is advantageous for assembly that the seal 8 has bevels or chamfers 88 and 89 in the assembly direction in the area of the thickened regions 82 and 83. This way, the seal 8 can be guided considerably more easily and precisely through the opening in the side wall 5 and 6 and the. chamfers 88 and 89 do not have to contribute to a sealing effect that is instead provided by the thickened regions 82 and 83.

Below the lug 15, the lower part 1 has an raised part or bump 151 that prevents bending of the seal 8 during assembly of the housing and at the same time improves strain relief. Alternatively, the seal 8 or the geometry of the housing can be configured such that following the assembly of the seal 8 it bears directly against the inside surface of the housing body.

In place of the stepped configuration of the seal 8, as illustrated in the drawing, it is conceivable that the seal 8 has a wavelike or corrugated shape, with the side walls 5 and 6 as well as the lug 15 resting against the seal 8 in the troughs of the corrugations, and the element is deformed such due to its flexible ductility that the peaks of the waves correspond to the thickened regions 81 to 84.

In place of a seal made of a flexible ductile material, inflexible or moderately flexible material can be used. In this case the geometries of the seal and the surrounding areas thereof in the housing are coordinated such that the seal 8 is pushed into the housing by force and as a result the sealing effect and/or strain relief is achieved. Alternatively or in addition, the seal 8 can also be inserted in the housing without or with only minimal force and then be glued, welded or the like in place.

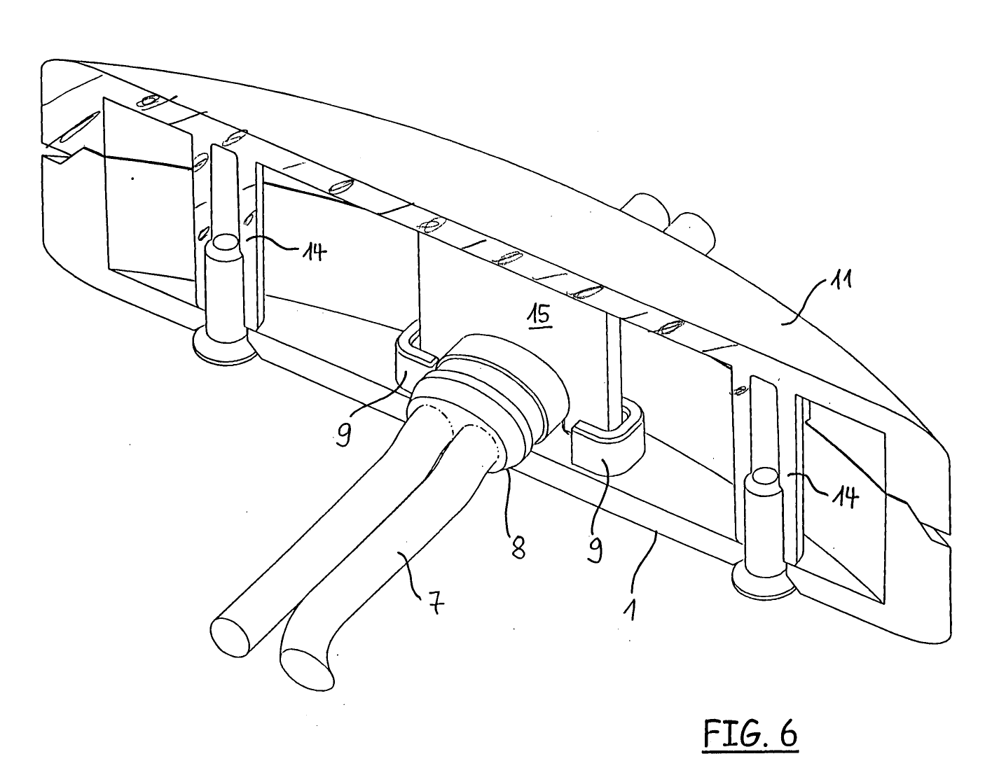

FIG. 6 shows a section through the complete housing of the antenna with the cable 7 and seal 8, with the fit between the seats 9 on the lower part 1 and the protruding lug 15 on the upper part 11 visible. This interaction that has no influence on the sealing function of the seal 8, relieves the cable 7 together with the seal 8 that is fixed there by a integral connection, from tensile or pressure forces. It can also be seen that the seal 8 may have not only a round, but also an oval, angular, or polygonal cross-section, in order to be able to install the cable 7 or more than one cable with seals 8 only in one position and achieve protection from distortion when operating the antenna. The cross-section can also be flattened in the surface area of a housing part, here the lower part 1. In case of a nonround seal 8, the shapes of the ports 20 and 21 in the side walls 5 and 6 and the lug 15 are of course changed accordingly.

While the illustrated embodiment shows that the seal 8 has chamfers 88 and 89 to facilitate installation, these chamfers can also be present additionally or alternatively in the area of the ports 20 and 21 of the side walls 5 and 6 of the housing and/or lug 15. In this case, the seal 8 could have only one recess in the area of a side wall or no recess at all. The strain relief and sealing effect could be achieved by the adequate flexible ductility, that is pinching, of the seal 8.

I claim:

1. A high-frequency motor-vehicle antenna comprising:
a lower housing part adapted to be secured to the motor vehicle, at least partially dielectric, and formed with an inner and an outer annular side wall;
an upper housing part formed with an inner and an outer annular side wall fittable with the respective walls of the lower part;
means securing the upper and lower housing parts together with the side walls fitting hermetically together, the inner and outer side walls forming aligned inner and outer throughgoing ports when the parts are fitted together;
a cable extending through the ports; and
a seal integrally mounted on the cable and sealingly fitting in both of the ports.

2. The motor-vehicle antenna defined in claim 1 wherein the seal acts as a strain-relief with the outer side walls.

3. The motor-vehicle antenna defined in claim 1 wherein the seal is unitary with the cable.

4. The motor-vehicle antenna defined in claim 1 wherein the seal has inner and outer ridges engaging the inner and outer side walls at the respective ports.

5. The motor-vehicle antenna defined in claim 1 wherein the seal is formed with a groove fitting with a lug on one of the parts.

6. The motor-vehicle antenna defined in claim 5 wherein the other of the parts is formed with a seat in which the lug fits when the parts are fitted together.

7. The motor-vehicle antenna defined in claim 1 wherein the seal has inwardly directed and inwardly tapering beveled edges, whereby the seal can be forced inwardly through the ports with elastic deformation of the seal.

8. The motor-vehicle antenna defined in claim 1 wherein one of the parts has spacers bearing vertically on the other of the parts when the parts are fitted together.

9. The motor-vehicle antenna defined in claim 1 wherein the seal is formed with an inner thickening fitting with elastic deformation in the inner port and an outer thickening fitting with elastic deformation in the outer port and is formed between the thickenings with an outwardly open groove, one of the parts being formed with a lug projecting toward the other part and fitting complementarily tightly in the groove and the other part being formed with a seat open toward the one part and receiving the lug.

10. The motor-vehicle antenna defined in claim 1 wherein both of the parts are made of a rigid plastic.

11. The motor-vehicle antenna defined in claim 1 wherein the seal is molded on the cable.

12. The motor-vehicle antenna defined in claim 1, further comprising
electronic elements fixed to one of the parts inward of the respective inner side wall.
